(19) United States
(12) Patent Application Publication
(10) Pub. No.: US 2005/0135703 A1
(43) Pub. Date: Jun. 23, 2005

(54) Method of removing stains from digital images

(76) Inventor: Zhuo Ya Wang, Taipei (TW)

Correspondence Address: RABIN & BERDO, P.C.;Suite 500, 1101 14 Street, N.W., Washington, DC, 20005, US

(21) Appl. No.: 10/737,862

(22) Filed: Dec. 18, 2003

(51) Int. Cl. G06K 9/40

(52) U.S. Cl. 382/275

(57) ABSTRACT

A method of removing stains from digital images. First, the differences between a selected pixel and its adjacent pixels are computed. Those adjacent pixels with a difference greater than a first standard value are marked as special points. The special points of the selected pixel are enumerated. The selected pixel with a number of special points greater than a second standard value is marked as a stained pixel. Finally, the stained pixel is filled. Not only is the processing speed greatly increased, the stains on the image can be effectively removed.

### BACKGROUND OF THE INVENTION

1. Field of Invention

The invention relates to a digital image processing method and, in particular, to a method of removing stains from digital images.

2. Related Art

With continuous development in the digital technology, digital images have wider applications. They can be obtained via various means. Once a digital image is obtained, it usually needs further processing before being satisfactory. Therefore, digital image processing is a very important issue.

In the digital images, there are usually some stain noises, such as the noises often happened to digital cameras. The noises are the noisy signals generated during the exposure process. They become various kinds of tiny stains in the image. As shown in FIGS. 1a and 1b, the image contains such stains as noises, seriously affecting the clearness of the image.

Conventional methods of removing stain noises can be divided into two groups. One utilizes a curl product method; the other uses an erosion expansion method. The basic principle of using the curl product method to remove stains is using a spatial low-pass filter to blur and lighten the stains. This method does not only lose effective high-frequency components to blur the image, the processing also takes more time. The erosion expansion method determines whether the selected area is brighter than its surrounding area, thereby finding seriously stained rectangular areas. Afterwards, the stained rectangular areas are eroded. The stains are filtered out from the areas. The image is restored using the expansion principle. When using this method of first erosion then expansion to remove stained noises from the image, the stained area is picked by checking an area is brighter than its surrounding area. This may result in missing some isolated area or isolated points. This is because the fact that not only those areas brighter than surrounding areas are stains, those darker than the surrounding areas may also be stains. Furthermore, after extracting the basic framework and filtering out the residual stains, some non-stained areas are inevitably also processed. Therefore, the normal points in the image are seriously removed too. Therefore, aside from precision determination of the positions of noisy stains in a digital image, increasing the image processing speed is also an important direction in the digital image processing technology.

### SUMMARY OF THE INVENTION

In view of the foregoing, the invention provides a method of removing stains from digital images. A primary objective of the invention is to provide a method of precising determining the position of stains and filling those stains in the image to make the image clearer. At the same time, the invention can increase the image processing speed.

To achieve the above objective, the disclosed digital image stain elimination method first compute differences between a selected pixel and its adjacent pixels. Those pixels with a difference greater than a first standard value are marked as special points. The number of the special points of the selected pixel is counted. The selected pixel with a number of special points greater than a second standard value is marked as a stained pixel. Finally, the stained pixel is filled.

According to the disclosed method, the stains in the image are first identified and positioned. By comparing the brightness of a point with its adjacent points, it is determined to be a stain or a normal point. If it is a stain, it is removed by filling the pixel using the average brightness of its surrounding pixels. This does not only greatly increase the processing speed, the stains in the image can be efficiently removed. The method is most effective for stains similar to pepper and has no consequence on normal points.

### BRIEF DESCRIPTION OF THE DRAWINGS

The invention will become more fully understood from the detailed description given hereinbelow illustration only, and thus are not limitative of the present invention, and wherein:

FIG. 1a and 1b are schematic views of digital images with stained noises;

FIG. 2 is a flowchart of the disclosed method of removing stains in a digital image; and

FIG. 3 is a schematic view of removing stains from the digital image.

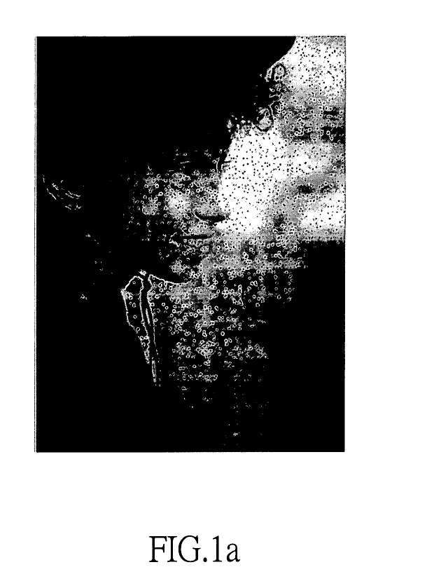

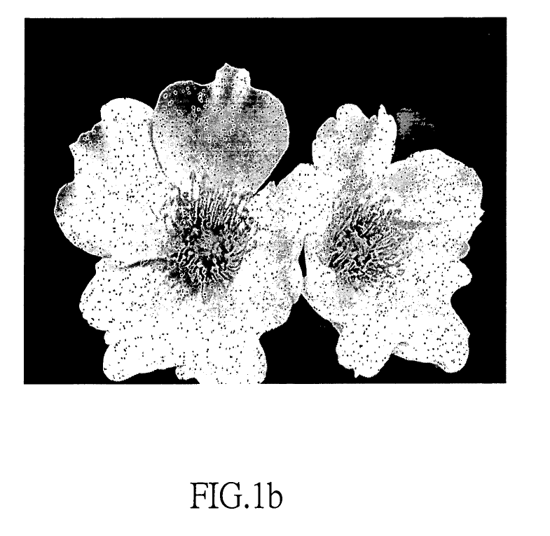

### DETAILED DESCRIPTION OF THE INVENTION

The disclosed method can be used in Windows operating system (OS) or in an embedded platform. The digital image described in the specification can be obtained through various means. The sources can be a digital image database stored in a CD-ROM or on the Internet. The images can be created using graphics software. Most of currently available graphical editing programs have certain drawing functions with powerful functions and a graphics user interface (GUT). One may also use digital devices, such as digital cameras and digital video cameras, to capture digital images or use digital conversion devices to collect images (e.g. converting analog images into digital images). Digital images can be obtained using all the above-mentioned methods. The digital images thus obtained may have stains because of bad maintenance or aging. One objective of the invention is to remove stains and unnecessary parts of an original image, thereby enhancing the clearness of the image.

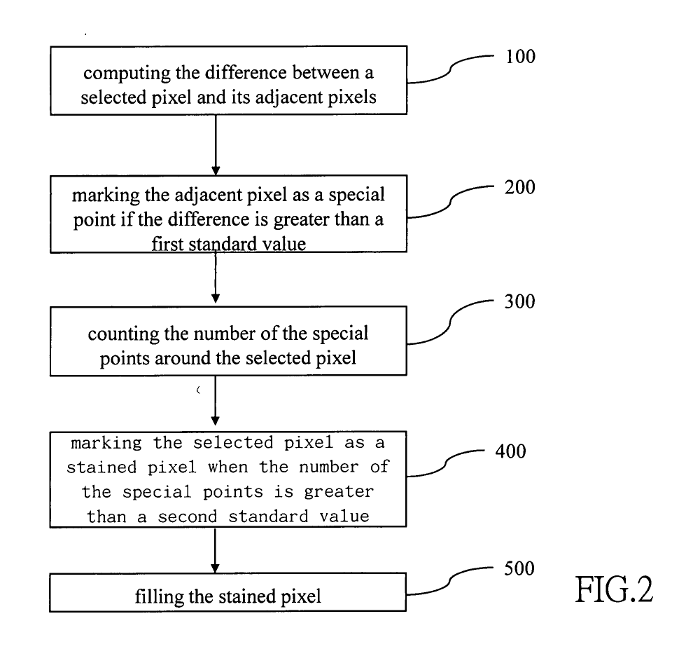

We use FIG. 2 to explain the procedure of the disclosed method. First, the system computes the differences between a selected pixel and its adjacent pixels (step 100). Those adjacent pixels with a difference greater than a first standard value are marked as special points (step 200). The system counts the number of the special points associated with the selected pixel (step 300). If the number of special points of the selected pixel is greater than a second standard value, it is marked as a stained pixel (step 400). Finally, the stained pixel is filled (step 500).

In the following, we use an example of eliminaing the stains in a color digital image to illustrate the spirit of the invention. First, one has to convert the image from the RGB format to the YcbCr format. Conversion from the RGB format to the YcbCr format is the most common conversion. All one needs to know is the coefficients for mapping from one format to the other. The rest is given in the following formulae:
Y=0.299R+0.587G+0.114B
Cb=−0.1687R−0.3313G+0.5B+128
Cr=0.5R−0.4187G−0.0813B+128

When processing the stains in an image, the most important step is locating the stains. Locating the stains is to mark stained pixels in the image. In the YcbCr format, each pixel in the image corresponds to a unique Y value, which represents the brightness of the pixel.

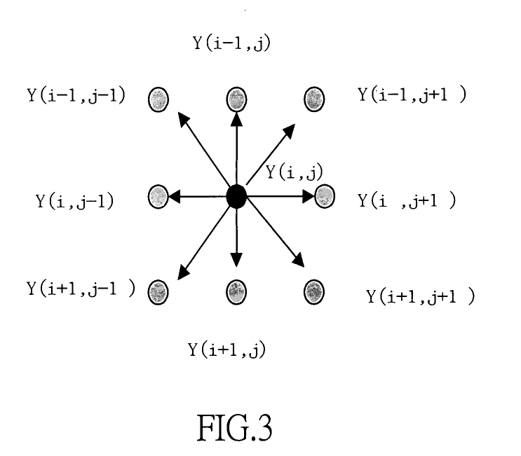

As shown in FIG. 3, the selected pixel is Y(i,j), the eight adjacent pixels are Y(i−1,j−1), Y(i−1,j), Y(i−1,j+1), Y(i,j+1), Y(i+1,j+1), Y(i+1,j), Y(i+1,j), and Y(i,j−1). Their relative positions are shown in the following table

| | | |
|---|---|---|
| Y(i − 1, j − 1) | Y(i − 1, j) | Y(i − 1, j + 1) |
| Y(i, j − 1) | Y(i, j) | Y(i, j + 1) |
| Y(i + 1, j − 1) | Y(i + 1, j) | Y(i + 1, j + 1) |

To locate the stains, one needs to compare the selected pixel with its surrounding pixels, computing the differences in between. An explicit implementation is to take the difference between the Y value of the selected pixel and that of each of the surrounding pixels. A counter is used to count the number of special points. If a difference is greater than a first standard value, the associated adjacent pixel is a special point and the counter is added by one. In the current embodiment, the first standard valuye is 7. After the subtraction operations are done for all the eight adjacent pixels, the counter value is read. If the counter value is greater than a second standard value, the selected pixel is marked as a stained pixel. In the current embodiment, the second standard value is 7. In other words, if the number of special points around the selected pixel Y(ij) is greater than 7, then it is a stained pixel.

The process goes on to the next pixel and repeats the above steps until all pixels in the image are processed. All stained pixels in the image are then marked.

Once the stained pixels are pinned down, the disclosed method starts to fill the stained pixels. There are many ways to perform the filling. A faster method is to take the average of the adjacent pixels in the up, down, left, right direction from the stained pixel. Suppose the stained pixel is Y(ij), then the system takes the average of the pixels Y(i−1,j), Y(i,j+1), Y(i+1,j), and Y(i,j−1). The average is used to fill the stained pixel. Likewise, one can use the average of all the surrounding pixels to increase the accuracy of the image processing.

Certain variations would be apparent to those skilled in the art, which variations are considered within the spirit and scope of the claimed invention.

1. A method of removing stains from a digital image, comprising the steps of:
computing the difference between a selected pixel and its adjacent pixels;
marking the adjacent pixel as a special point if the difference is greater than a first standard value;
counting the number of the special points around the selected pixel;
marking the selected pixel as a stained pixel when the number of the special points is greater than a second standard value; and
filling the stained pixel.

2. The method of claim 1 further comprising the step of converting the image to the YcbCr format.

3. The method of claim 1, wherein all of the adjacent pixels are the eight pixels surrounding the selected pixel.

4. The method of claim 1, wherein the first standard value is 7.

5. The method of claim 1, wherein the second standard value is 7.

6. The method of claim 1, wherein the selected pixel goes over all pixels in the image.

7. The method of claim 1, wherein the step of filling the pixel is implemented by filling the stained pixel the average of the adjacent pixels in the up, down, left, right direction from the stained pixel.

8. The method of claim 1, wherein the step of filling the pixel is implemented by filling the stained pixel the average of the eight adjacent pixels that surround the stained pixel.

9. The method of claim 1 applied to the Windows operating system.

10. The method of claim 1 applied to an embedded platform.
